(19) United States
(12) Patent Application Publication
(10) Pub. No.: US 2013/0203015 A1
(43) Pub. Date: Aug. 8, 2013

(54) GINGIVAL TISSUE CONTOUR DEVICE

(71) Applicant: James Falco, Schnecksville, PA (US)

(72) Inventor: James Falco, Schnecksville, PA (US)

(73) Assignee: James Falco, Schnecksville, PA (US)

(21) Appl. No.: 13/743,850

(22) Filed: Jan. 17, 2013

Related U.S. Application Data
(60) Provisional application No. 61/587,362, filed on Jan. 17, 2012.

(51) Int. Cl. A61C 8/00

(52) U.S. Cl. CPC A61C 8/008
USPC 433/173

(57) ABSTRACT

Gingival tissue contour devices, systems, and methods are presented, and comprise a gingival tissue contour cap having one or more connectors on its bottom portion for securing the cap to one or more complementary connectors on the top portion of a healing cap. The gingival tissue contour cap has substantially the shape, dimensions, and contouring of the neck of a tooth. The combined height of the gingival tissue contour cap and a healing cap is approximately equal to the depth of gingival tissue.

### CROSS REFERENCE TO RELATED APPLICATIONS

This application claims priority to U.S. Provisional Application No. 61/587,362, filed on Jan. 17, 2012, the contents of which are incorporated by reference herein, in their entirety and for all purposes.

### FIELD OF THE INVENTION

The invention relates generally to the field of implant dentistry. More particularly, the invention relates to contour devices, systems, and methods for shaping gingival tissue to accommodate the shape of a tooth prosthesis which is secured into an implant in the jawbone.

### INTRODUCTION TO THE INVENTION

Various publications, including patents, published applications, technical articles and scholarly articles are cited throughout the specification. Each of these cited publications is incorporated by reference, in its entirety and for all purposes, in this document.

Implant dentistry includes the replacement of a diseased, damaged, or missing tooth with a prosthetic tooth. The implant process generally proceeds in stages over a period of weeks, beginning with the removal of the tooth to be replaced, or any remnants thereof.

After the tooth is removed, a surgeon dissects the patient's gingival tissue to access the bone where the implant will be anchored. The surgeon creates a hole in the bone sufficiently wide and deep to accommodate a dental implant, and then anchors the implant in place within the bone. The implant includes an opening, the top which is in communication with a channel through the medial portion of the implant, and this channel typically includes screw threads to secure a prosthetic tooth when the bone heals sufficiently to accommodate the force and pressure of chewing food. Once the implant is in place, the surgeon will close the opening with a temporary cover, and will suture the gingival tissue over the implant to allow the area to heal and osseointegration of the implant to proceed.

After a period of weeks, the second stage of the implant process is carried out. During this stage, a surgeon removes the gingival tissue surrounding the top of the dental implant, removes the temporary cover, and installs a healing cap into the implant. Generally, the healing cap is screwed into the implant channel, with the top portion (i.e., the cap) of the healing cap seated above the top of the implant. After installation of the healing cap, the gingival tissue is allowed to heal for an additional few weeks, after which the healing cap is removed and the prosthetic tooth installed.

While the healing cap is in place, the gingival tissue grows and heals around the healing cap, eventually assuming the shape of the healing cap. Accordingly, a healing cap having a top portion with a height about the same as the patient's gingival tissue is used. The standard healing cap top portion is circular/cylindrical in shape. This is to allow the healing cap to be easily screwed out from the implant when it is time to install the prosthetic tooth. The circular shape of the top portion prevents injury to the gingival tissue during removal of the healing cap. For example, if the top portion were any other shape, the edges of the top portion would rip the gingival tissue during rotation when the healing cap is screwed out of the implant.

Because the healing cap top portion is cylindrical, the gingival tissue assumes the cylindrical shape of the healing cap as it heals around the healing cap. Thus, when the healing cap is removed, the gingival tissue essentially has the shape of the negative of the healing cap. But the prosthetic tooth is not cylindrical in shape; rather, the prosthetic tooth mimics the shape, contours, and dimensions of the tooth it is to replace.

Thus, in order to install the prosthetic tooth, the dentist must re-contour the cylindrical-shaped gingival tissue in the shape of the prosthetic tooth in order to allow the prosthesis to fit snugly into the gingival tissue, as well as to provide a natural appearance for the prosthetic tooth. The re-shaping of the gingival tissue can cause additional discomfort to the patient, and adds time and cost to the procedure. Therefore, a need exists to simplify, perhaps eliminate, the process for re-contouring the gingival tissue.

### SUMMARY OF THE INVENTION

The invention features gingival tissue contour systems. The systems generally comprise a gingival tissue contour cap comprising a top, one or more sidewalls having substantially the buccolingual dimension, the mesiodistal dimension, and the shape of the neck of a tooth and having a height of about 1 mm to about 3, and a bottom having one or more connectors for engaging one or more connectors on a healing cap head, and comprise a healing cap comprising a cylindrical and substantially round head having one or more connectors extending in an upward direction from the top of the head for engaging one or more connectors on the gingival tissue contour cap and securing the gingival tissue contour cap to the top of the head, and having a height of about 1 mm to about 3 mm and a diameter of about 3 mm to about 6 mm, and a shaft extending in a downward direction from the bottom of the head and having screw threads compatible with the screw threads of a dental implant fixture. The gingival tissue contour cap is preferably comprised of a biocompatible plastic material, polymeric material, or composite thereof and the healing cap is preferably comprised of a biocompatible metal. Optionally, the system may comprise a dental implant. Optionally, the system may comprise a prosthetic tooth to be secured in the dental implant once the contour cap and healing cap are removed.

The one or more connectors on the healing cap may comprise a post or a flange oriented vertically relative to the plane of a patient's upper or lower jaw. The post or flange may further comprise a tongue around the perimeter of the post or flange. The post or flange may comprise screw threads. The post or flange may comprise any suitable shape, with a star-shape being preferred. The one or more connectors on the bottom of the gingival tissue contour cap may comprise a socket, which is substantially the same shape as the post or flange on the healing cap, albeit slightly wider to allow the post or flange to fit within the socket, for example, with a friction fit. The socket may comprise a groove around the internal perimeter of the socket, and into this groove, the tongue on the post or flange is inserted when the gingival tissue contour cap is joined to the healing cap, and the tongue-groove connection affixes the contour cap and healing cap together or otherwise enhances the friction fit connection such that the contour cap does not fall off of the healing cap, particularly under the mechanical stress of chewing food or brushing teeth. The socket may comprise screw threads.

The one or more sidewalls of the gingival tissue contour cap may comprise substantially the shape, substantially the buccolingual dimension, and/or substantially the mesiodistal dimension of the neck of a tooth. The neck shape and dimensions may be those of a maxillary or mandibular central incisor tooth, lateral incisor tooth, cuspid tooth, first bicuspid tooth, second bicuspid tooth, first molar tooth, or second molar tooth. The one or more sidewalls may comprise a height of about 0.5 mm to about 8 mm. The height may be about 1 mm, about 2 mm, or about 3 mm. The sidewalls thus approximate the shape, contours, and dimensions of the neck of a tooth being replaced with a prosthetic tooth.

The gingival tissue contour cap may comprise a bore extending from the top to the bottom and through the cap, having an opening on the top and an opening on the bottom of the contour cap. The bore may be substantially medial through the contour cap, relative to the side walls. Preferably, the bore aligns with a notch on the top of the healing cap, which is used to turn the healing cap to secure it into a dental implant. The bore allows a user to access the notch through the tissue contour cap, without removing the contour cap from the healing cap, in order to tighten or loosen the healing cap.

The gingival tissue contour cap may comprise one or more frangible zones, which may be present on the one or more sidewalls and/or the top of the contour cap. The frangible zones may comprise a thinner thickness of the plastic, polymeric, or composite materials, relative to the thickness of the one or more sidewalls of the contour cap, or comprise a series of perforations. The frangible zones may comprise a pull tab connected to a thread, which may extend circumferentially around the sidewalls or top of the cap and when pulled may compromise the cap. The frangible zones may comprise one or more ports extending into and/or through the cap into which a wedge may be inserted to compromise the integrity of the cap. Alternative to a frangible zone, one or more ports, flaps, or loops may be present on or extend into the top of the contour cap or the sidewalls of the contour cap, and such ports or flaps allow a user to snare the contour cap with a tool (e.g., a hook, a screw driver, forceps, or other suitable tool) and pull the contour cap off of the healing cap.

The invention features kits for contouring gingival tissue. The kits may comprise a gingival tissue contour system, and instructions for using the system in a method for contouring gingival tissue. The system generally comprises a gingival tissue contour cap comprising a top, one or more sidewalls having substantially the buccolingual dimension, the mesiodistal dimension, and the shape of the neck of a tooth and having a height of about 1 mm to about 3, and a bottom having one or more connectors for engaging one or more connectors on a healing cap head. The system generally comprises a healing cap comprising a substantially cylindrical head having one or more connectors for engaging one or more compatible connectors on the gingival tissue contour cap and securing the gingival tissue contour cap to the top of the head, and having a height of about 1 mm to about 3 mm and a diameter of about 3 mm to about 6 mm, and a shaft having screw threads compatible with the screw threads of a dental implant fixture. The gingival tissue contour cap is preferably comprised of a biocompatible plastic material, polymeric material, or composite thereof. The one or more sidewalls of the gingival tissue contour cap may comprise substantially the shape, substantially the buccolingual dimension, and/or substantially the mesiodistal dimension of the neck of a tooth. The neck shape and dimensions may be those of a maxillary or mandibular central incisor tooth, lateral incisor tooth, cuspid tooth, first bicuspid tooth, second bicuspid tooth, first molar tooth, or second molar tooth. The one or more sidewalls may comprise a height of about 0.5 mm to about 8 mm. The height may be about 1 mm, about 2 mm, or about 3 mm.

The kits may further comprise a plastic material, a polymeric material, or a composite material thereof for adhering to and enlarging the buccolingual dimension and/or the mesiodistal dimension of the gingival tissue contour cap, and instructions for using the plastic material, a polymeric material, or a composite material thereof to enlarge the buccolingual dimension and/or the mesiodistal dimension of the gingival tissue contour cap.

Optionally, the kits may further comprise a dental implant compatible with the healing cap, and instructions for using the dental implant in a method for contouring gingival tissue. Optionally, the kits may further comprise a prosthetic tooth compatible with the dental implant.

The invention also features methods for contouring gingival tissue in a patient in need thereof, including a human patient. Generally, the methods comprise connecting a gingival tissue contour cap to a healing cap implanted in the jaw of a patient for a period of time sufficient to allow the gingival tissue of the patient to grow and heal around one or more sidewalls of the gingival tissue contour cap, thereby assuming the shape of the one or more sidewalls.

The gingival tissue contour cap comprises a top, one or more sidewalls having substantially the buccolingual dimension, the mesiodistal dimension, and the shape of the neck of a tooth and having a height of about 1 mm to about 3, and a bottom having one or more connectors for engaging one or more connectors on a healing cap head. The healing cap comprises a substantially cylindrical head having one or more connectors for engaging one or more compatible connectors on the gingival tissue contour cap and securing the gingival tissue contour cap to the top of the head, and having a height of about 1 mm to about 3 mm and a diameter of about 3 mm to about 6 mm, and comprises a shaft having screw threads compatible with the screw threads of a dental implant fixture. The gingival tissue contour cap is preferably comprised of a biocompatible plastic material, polymeric material, or composite thereof.

The one or more sidewalls of the gingival tissue contour cap may comprise substantially the shape, substantially the buccolingual dimension, and/or substantially the mesiodistal dimension of the neck of a tooth. The neck shape and dimensions may be those of a maxillary or mandibular central incisor tooth, lateral incisor tooth, cuspid tooth, first bicuspid tooth, second bicuspid tooth, first molar tooth, or second molar tooth. The one or more sidewalls may comprise a height of about 0.5 mm to about 8 mm. The height may be about 1 mm, about 2 mm, or about 3 mm.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawings are the following figures:

FIG. 1A shows a gingival tissue contour cap with three sockets along with a healing cap with three prongs;

FIG. 1B shows a gingival tissue contour cap with a screw-threaded socket along with a healing cap with a screw-threaded flange;

FIG. 1C shows a gingival tissue contour cap with a round socket along with a healing cap with a flange having barbs;

FIG. 1D shows a gingival tissue contour cap with a star-shaped socket having a groove along with a healing cap with a star-shaped post having a tongue structure that aligns with the groove in the socket to lock the contour cap in place on the healing cap;

FIG. 2A shows a top perspective of an incisor-shaped gingival tissue contour cap;

FIG. 2B shows a bottom perspective of an incisor-shaped gingival tissue contour cap having three sockets and a bore;

FIG. 2C shows a bottom perspective of an incisor-shaped gingival tissue contour cap having three sockets and no bore;

FIG. 2D shows a bottom perspective of an incisor-shaped gingival tissue contour cap having four cross-shaped sockets an no bore;

FIG. 3A shows a gingival tissue contour cap with three prongs along with a healing cap with three sockets;

FIG. 3B shows a gingival tissue contour cap with a screw-threaded flange along with a healing cap with a screw-threaded socket;

FIG. 3C shows a gingival tissue contour cap with a flange along with a healing cap with a socket;

FIG. 4A shows the MD and BL dimensions and shape of a mandibular molar;

FIG. 4B shows the MD and BL dimensions and pentagonal shape of a mandibular first molar;

FIG. 4C shows the MD and BL dimensions and slightly rectangular to rhomboid shape of a mandibular second molar;

FIG. 4D shows the MD and BL dimensions and rhomboid parallelogram shape of a maxillary molar;

FIG. 4E shows the MD and BL dimensions and heart shape of a maxillary second molar;

FIG. 4F shows the MD and BL dimensions and pentagonal shape of a mandibular bicuspid;

FIG. 4G shows the MD and BL dimensions and rectangular shape of a mandibular second bicuspid;

FIG. 5A shows a healing cap having three fasteners;

FIG. 5B shows a healing cap having four fasteners;

FIG. 6A shows a gingival tissue contour cap having frangible zones in the form of break-away portions of the cap;

FIG. 6B shows a gingival tissue contour cap having frangible zones in the form of slots for dental tools;

FIG. 6C shows a gingival tissue contour cap having a frangible zone in the form of a pull-tab and thread;

FIG. 7A shows a prosthetic tooth installed into a dental implant;

FIG. 7B shows an exploded view of the prosthetic tooth and dental implant;

FIG. 8 shows an implant in the jaw bone of a patient, with a healing cap installed into the implant spanning a portion of the depth of the gingival tissue, and a gingival tissue contour cap secured to the healing cap and spanning the remainder of the depth of the gingival tissue, between two teeth; and,

FIG. 9 shows an implant in the jaw bone of a patient, with a standard healing cap installed into the implant and spanning the full depth of the gingival tissue, between two teeth.

### DETAILED DESCRIPTION OF THE INVENTION

Various terms relating to aspects of the present invention are used throughout the specification and claims. Such terms are to be given their ordinary meaning in the art, unless otherwise indicated. Other specifically defined terms are to be construed in a manner consistent with the definition provided in this document.

As used throughout, the singular forms “a,” “an,” and “the” include plural referents unless expressly stated otherwise.

The terms subject or patient are used interchangeably. A patient may be any animal, including mammals such as companion animals, laboratory animals, and non-human primates. Human beings are preferred.

The invention features devices, systems, and methods for contouring gingival tissue in a patient in need thereof, for example, a dental implant patient. The devices, systems, and methods may find use, for example, in implant dentistry. A foundational feature is a gingival tissue contour cap.

The components of the gingival tissue contour device can be fabricated from any suitable material or combination of materials. Materials include plastic, polymers, glass, rubber, metal, and composites, preferably medical or surgical grade, and preferably biocompatible. Non-limiting examples of suitable polymers include polyetheretherketone (PEEK), polyamineimide (PAI), polyethyleneimine (PEI), polyphenylsulfone (PPSU), polyoxymethylene (POM), and ultra high molecular weight polyethylene (UHMW-PE). Such materials include those marketed under the trade names Motis® and Endolign®. Non-limiting examples of suitable metals include titanium, aluminum, and surgical-grade steel.

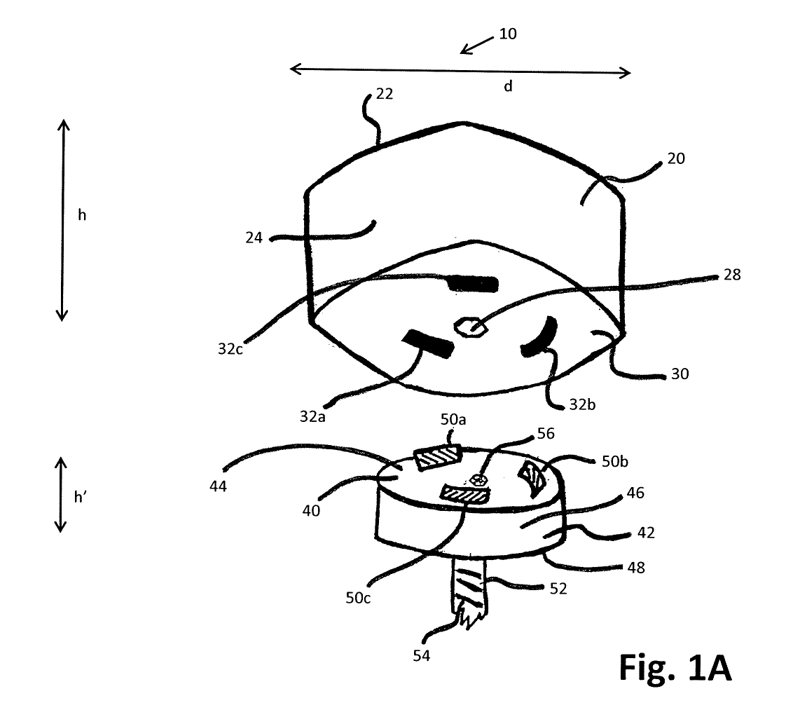

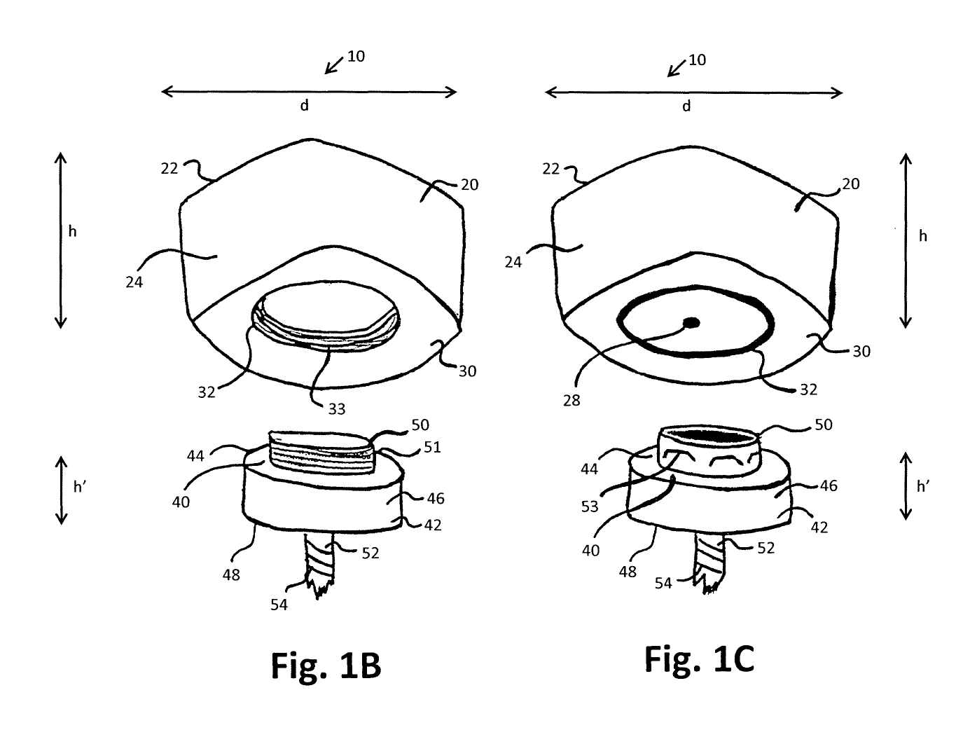

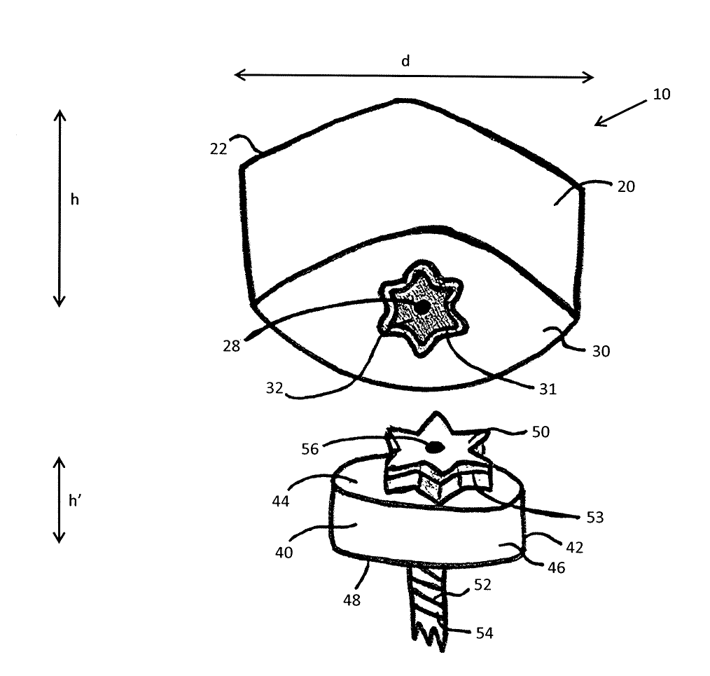

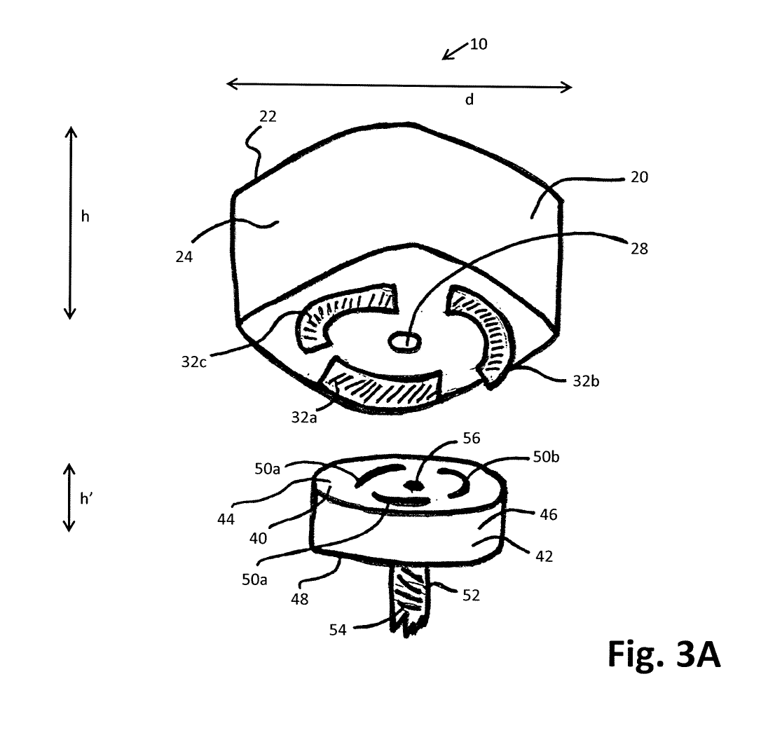

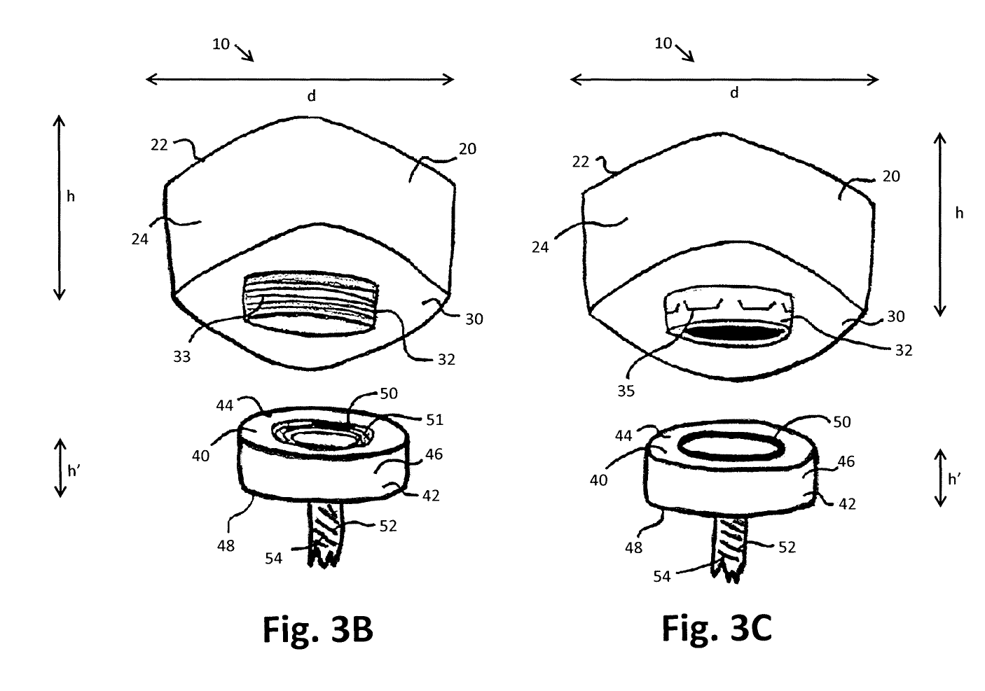

Referring now to the drawings, in which like reference numbers refer to like elements throughout the various figures that comprise the drawings, FIG. 1A-1D and FIG. 3A-3C show some non-limiting embodiments of a gingival tissue contour system 10. The gingival tissue contour system 10 comprises a gingival tissue contour cap 20, which comprises a top 22, one or more sidewalls 24, a bottom 30, and one or more contour cap connectors 32 (shown as a non-limiting embodiment with three contour cap connectors 32a, 32b, and 32c in FIG. 1A) for engaging one or more healing cap connectors 50 (shown as a non-limiting embodiment with three healing cap connectors 50a, 50b, and 50c in FIG. 1A) that are preferably localized on the head 42 of a healing cap 40.

The gingival tissue contour cap 20 may comprise a bore 28 with an opening on the top 22 and an opening on the bottom 30, and which extends through the tissue contour cap 20, preferably extending substantially at about the middle of the contour cap 20, relative to the sidewalls, considering that the sidewalls 24 and contour cap 20 may comprise an irregular shape. The bore 28 may function to allow access to the notch that mates with a tool that is used to turn the healing cap 40 in order to secure the healing cap 40 to a dental implant 70, for example, to allow a user to access the notch 56 with a tool such as a screw driver through the contour cap 20 without removing the contour cap 20 from the healing cap 40, and tighten or loosen the healing cap 40 by turning the healing cap 40. For example, a practitioner may extend an appropriate dental tool through the bore 28, where it can engage the notch 56 and be turned in a clockwise or counterclockwise direction to tighten or loosen the healing cap 40. In some preferred aspects, the contour cap 20 includes only a single bore 28.

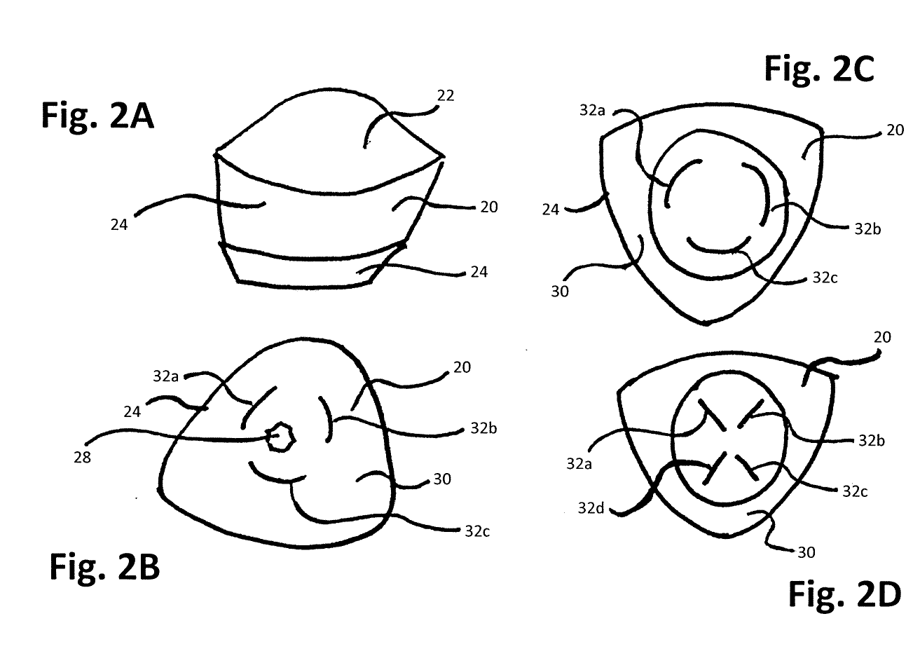

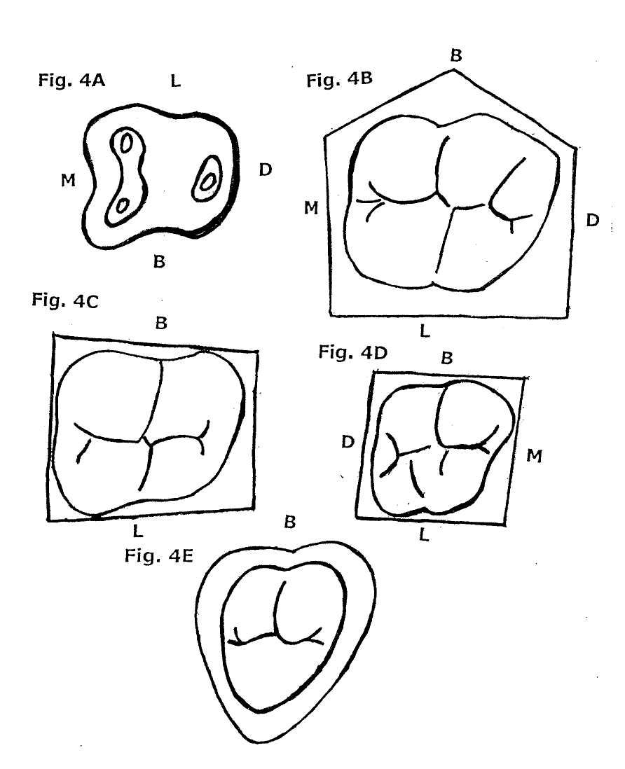

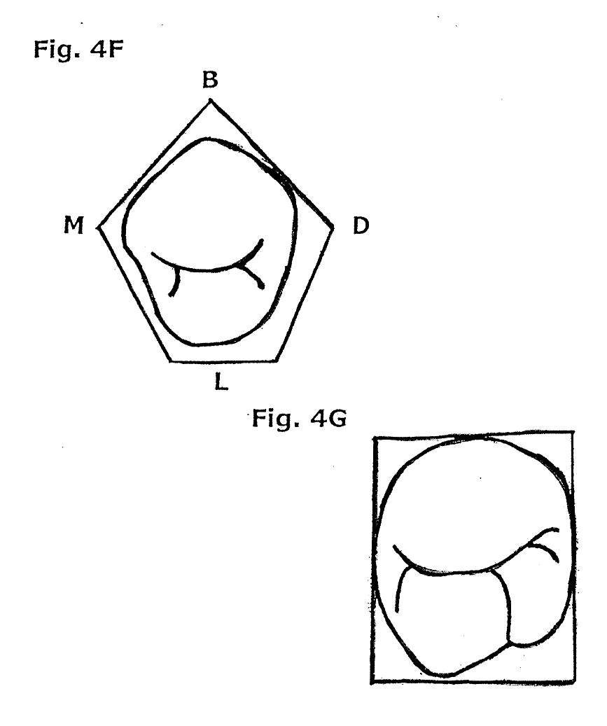

The one or more sidewalls 24 of the contour cap 20 preferably are substantially in the shape of the neck of a tooth 80, including a prosthetic tooth. FIG. 2A-FIG. 2D, and FIG. 4A-FIG. 4G show non-limiting examples of suitable shapes. Additionally, the one or more sidewalls 24 of the contour cap 20 preferably have a dimension d such as the buccolingual (BL) dimension and/or the mesiodistal (MD) dimension of a tooth 80, including a prosthetic tooth 80. The tooth may be a maxillary tooth or a mandibular tooth. The one or more sidewalls 24 may taper outward from or inward toward the midline of the contour cap 20. The sidewalls thus may approximate the shape, dimensions, and contours of the neck of a tooth. A tooth 80 may be a central incisor, a lateral incisor, a cuspid (canine), a first bicuspid, a second bicuspid, a first molar, or a second molar. An illustration of the buccolingual and mesiodistal dimensions as well as the neck shape of these tooth types is shown in FIG. 4A-4G. In addition, average dimensions for each are presented in Table 1 below (mm=millimeters).

TABLE 1
Buccolingual and mesiodistal dimensions
of maxillary and mandibular tooth types.

| | Maxillary | | Mandibular | |
|---|---|---|---|---|
| Tooth Type | MD (mm) | BL (mm) | MD (mm) | BL (mm) |
| Central Incisor | 6.4 | 6.3 | 3.5 | 5.4 |
| Lateral Incisor | 4.7 | 5.8 | 3.8 | 5.8 |
| Cuspid | 5.6 | 7.6 | 5.2 | 7.5 |
| First Bicuspid | 4.8 | 8.2 | 4.8 | 7.0 |
| Second Bicuspid | 4.7 | 8.1 | 5.0 | 7.3 |
| First Molar | 7.9 | 10.7 | 9.2 | 9.0 |
| Second Molar | 7.6 | 10.7 | 9.1 | 8.8 |

The one or more sidewalls 24 also have a height h. The height h may be about 0.5 mm to about 8 mm, and preferably about 1 mm to about 5 mm, about 1 mm to about 4 mm, about 1 mm to about 3 mm, about 1 mm to about 2 mm, about 2 mm to about 4 mm, about 2 mm to about 3 mm, about 2 mm to about 5 mm, about 3 mm to about 4 mm, about 3 mm to about 5 mm, about 3 mm to about 6 mm, about 4 mm to about 5 mm, about 4 mm to about 6 mm, about 4 mm to about 8 mm, about 5 mm to about 6 mm, about 5 mm to about 7 mm, or about 6 mm to about 8 mm. The height h may be about the depth of a patient's gingival tissue, measured from the top of the gingival tissue to the top of the bone. The height h may be a fraction of the depth of a patient's gingival tissue, measured from the top of the gingival tissue to the top of the bone, for example, a quarter, a third, a half, two thirds, or three quarters of the depth.

The one or more sidewalls 24 preferably are between the top 22 and bottom 30 of the contour cap 20, and do not extend lower than the bottom 30 of the contour cap 20. For example, the sidewalls 24 preferably do not cover any sidewalls 46, or significant portion thereof, of the healing cap 40 when the contour cap 20 and healing cap 40 are connected.

The one or more sidewalls 24 preferably comprise a shape that is substantially the shape of the neck of the type of tooth that the prosthetic tooth will replace. Thus, in some aspects, the one or more sidewalls 24 may comprise substantially the shape, dimensions, and contouring of the neck of a maxillary or mandibular central incisor, a maxillary or mandibular lateral incisor, a maxillary or mandibular cuspid (canine), a maxillary or mandibular first bicuspid, a maxillary or mandibular second bicuspid, a maxillary or mandibular first molar, or a maxillary or mandibular second molar, for example, a cross section as shown in any of FIG. 4A-4G.

The bottom 30 of the gingival tissue contour cap 20 comprises one or more contour cap connectors 32. The one or more connectors 32 preferably match with and engage one or more healing connectors 50 present on the top 44 of the head 42 of a healing cap 40. The gingival tissue contour cap connectors 32 serve to securely connect the gingival tissue contour cap 20 to the healing cap 40. The connection between the contour cap connectors 32 and the healing cap connectors 50 is preferably releasable, but is of sufficient strength that the connection remains secure over the normal forces encountered in the patient's mouth, including the forces and pressures caused by biting, chewing, or brushing, or by tongue movement. FIG. 2B and FIG. 2C show a non-limiting example of three contour cap connectors 32a, 32b, and 32c, and FIG. 2D shows a non-limiting example of four contour cap connectors 32a, 32b, 32c, and 32d. Embodiments with one, two, three, four, five, six, seven, eight, nine, ten, or more such connectors 32 are possible.

The contour cap connector 32 and the healing cap connector 50 preferably engage each other in a friction fit, or a snap-fit. It is preferred that the gingival tissue contour cap 20 and the healing cap 40 are not held together by any adhesive, glue, or cement, although an adhesive, glue, or cement may be used in some aspects, including to enhance the strength of the connection between the contour cap connectors 32 and the healing cap connectors 50.

The connection between the contour cap connectors 32 and the healing cap connectors 50 may comprise a male connector-female connector relationship. The one or more contour cap connectors 32 and the one or more healing cap connectors 50 may be either a male-type of connector or a female-type connector. Either or both of the contour cap connectors 32 and healing cap connectors 50 may comprise compatibly shaped undercuts 32, 50 that form an interlocking joint when each type of connector is joined together to connect the tissue contour cap to the healing cap.

In some aspects, the gingival tissue contour cap 20 comprises one contour cap connector 32, which may, for example, be a flange 32 or a post 32 (FIG. 3B and FIG. 3C). The flange 32 or post 32 may have any suitable shape, including a substantially circular, substantially elliptical, substantially triangular, substantially rectangular, substantially hexagonal, or substantially octagonal shape, though other shapes having any number of sides, including a star shape, and including irregular shapes, can be used. The flange 32 or post 32 may engage a complementary socket 50 on the head 42 of the healing cap 40. The flange 32 or post 32 is preferably vertically-oriented, for example, perpendicular to the plane of a patient's upper and/or lower jaw.

The flange 32 or post 32 may comprise a plurality of barbs or hooks 35, FIG. 3C, may comprise a lip 35, may comprise one or more tongue structures 35, may comprise one or more grooves 35, and/or may comprise screw threads 33, FIG. 3B. Thus, the contour cap connectors 32 may comprise structural features that do not impede the initial connection between the contour cap connector 32 and the healing cap connector 50 when the user is connecting the contour cap 20 and the healing cap 40 together, but are adapted to engage a complementary structural feature on the healing cap 40, including the healing cap connector 50, to further strengthen and secure the connection once made. For example, the contour cap connectors 32 may allow the user to join the tissue contour cap 20 and healing cap 40 together, but once joined, the contour cap 20 is locked in place on the healing cap 40. The structural features may be spring-loaded, or may be sufficiently flexible so as not to impede the initial connection between the connectors, but to flex back and lock into place once the contour cap 20 and the healing cap 40 are in the proper orientation in the patient's mouth.

The plurality of barbs or hooks 35 (or tongue 35), if present, may engage a plurality of grooves 53, snares 53, or 53 loops on the healing cap connector 50, in order to help secure the connection between the contour cap 20 and the healing cap 40. A lip 35, if present, may engage a circumferential groove 53 on the healing cap 40. The one or more grooves 35, if present, may engage one or more lips 53 or ridges 53 on the healing cap 40. The screw threads 33, if present, may engage complementary screw threads 51 on the healing cap 40.

In some aspects, the gingival tissue contour cap 20 comprises more than one contour cap connector 32, which may, for example, comprise a plurality of fasteners 32. The contour cap 20 may comprise two, three, four, five, six, seven, eight, nine, ten, or more fasteners 32. FIG. 3A shows a non-limiting example with three fasteners 32a, 32b, and 32c. As with the flange 32 or post 32, a fastener 32 may comprise structural features that do not impede the initial connection between the contour cap connector 32 and the healing cap connector 50 when the user is connecting the contour cap 20 and the healing cap 40 together, but are adapted to engage the a complementary structural feature on the healing cap 40, including the healing cap connector 50, to further strengthen and secure the connection once made. The structural features may be spring-loaded, or may be sufficiently flexible so as not to impede the initial connection between the connectors, but to flex back and lock into place once the contour cap 20 and the healing cap 40 are in the proper orientation in the patient's mouth. Each fastener 32, or fewer than each fastener 32, may comprise a plurality of barbs or hooks, may comprise a lip, or may comprise one or more grooves. The one or more fasteners 32 may comprise, for example, a prong 31, rivet 31, snap button 31, tongue 31, rod 31, clasp 31, or clip 31. The one or more fasteners 32 are preferably vertically-oriented, for example, perpendicular to the plane of a patient's upper and/or lower jaw.

In some preferred aspects, the gingival tissue contour cap 20 comprises one or more sockets 32, FIG. 1A-FIG. 1C, and FIG. 2B-FIG. 2D. The one or more sockets 32 may, for example, comprise a recessed portion(s) of the bottom 30 of the tissue contour cap 20. It is highly preferred that the one or more sockets 32 do not extend through the contour cap 20, and that aside from any socket 32, the contour cap 20 does not include any chambers. The contour cap connector 32 may engage a flange 50, a post 50, or a plurality of fasteners 50 on the head 42 of a healing cap 40. FIG. 1A and FIG. 2B show a non-limiting embodiment with three sockets 32a, 32b, and 32c arranged in a substantially circular orientation. FIG. 1D shows a preferred embodiment with a single socket 32 comprising a star-shape. FIG. 2D shows a non-limiting embodiment with four sockets 32a, 32b, 32c, and 32d arranged in a cross-orientation. The one or more sockets 32 may comprise screw threads 33, FIG. 1B, or may comprise one or more grooves 31 (FIG. 1D), or may comprise one more slots or notches, for example, to accommodate barbs 53 or tongue structure 53 on the healing cap connector 50. The one or more sockets 32 are preferably vertically-oriented, for example, perpendicular to the plane of a patient's upper and/or lower jaw.

In highly preferred aspects, the gingival tissue contour cap 20 comprises a star-shaped socket 32, with the socket 32 optionally further comprising a groove 31 or undercut 31 inside and preferably substantially around the perimeter of the socket 32. The healing cap 40 comprises a star-shaped post 50 or flange 50, with the post 50 or flange 50 optionally further comprising a tongue structure 53 or undercut 53 preferably substantially around the perimeter of the post 50 or flange 50. Thus, when the gingival tissue contour cap 20 is joined to the healing cap 40, the star-shaped post 50 or flange 50 is inserted into the star-shaped socket 32, and if present, the tongue structure 53 or undercut 53 is inserted into the groove 31 or undercut 31. The tongue and groove-type of connection between the tongue 53/undercut 53 and the socket 32/undercut 32 may facilitate a snap-fit, or otherwise reinforce or enhance the connection between the contour cap 20 and the healing cap 40 so that the two caps 20, 40 do not come apart under the normal mechanical stresses caused by, for example, chewing food, brushing teeth, or movement of the patient's tongue muscle. The star may comprise any suitable number of “points,” and a six-pointed star is shown in FIG. 1D for illustration purposes only. A star shape may comprise four, five, six, seven, eight, nine, ten, eleven, twelve, or more points.

The gingival tissue contour cap 20 may be fabricated from a material that allows the contour cap 20 and/or the one or more contour cap connectors 32 to be softened, for example, by heating to an appropriate temperature (e.g., in an oven or water bath), and placed over top of the healing cap 40 or healing cap connector 50 such that when the gingival tissue contour cap 20 and/or its one or more contour cap connectors 32 cools, it hardens securely in place.

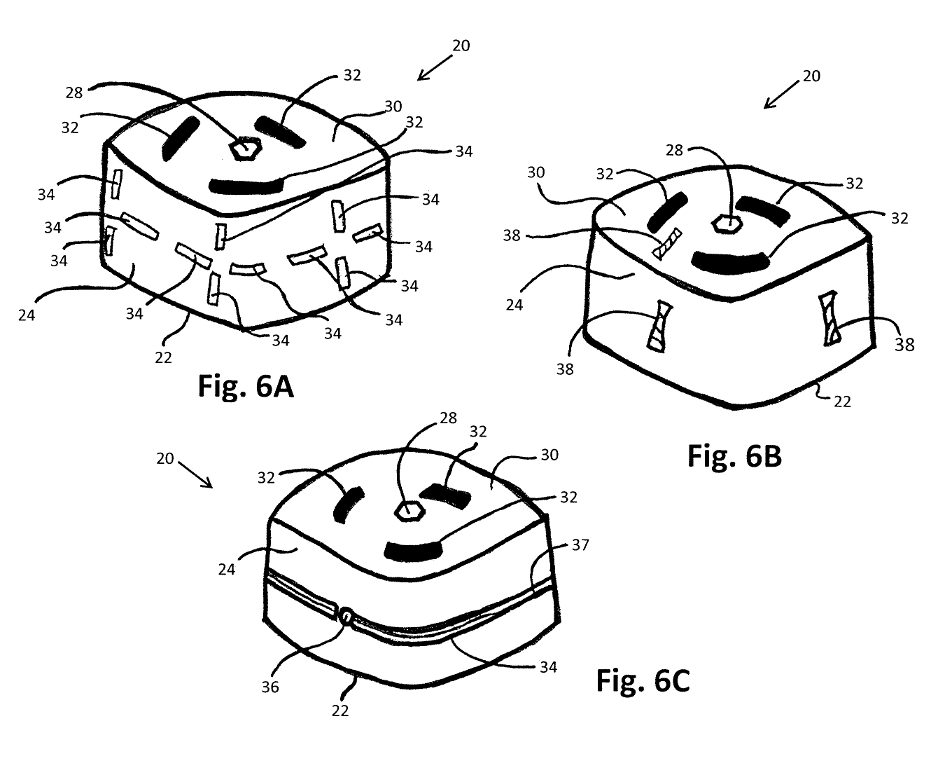

In some aspects, the gingival tissue contour cap 20 includes structural features that allow the contour cap 20 to be disengaged and removed from healing cap 40 if and when necessary to do so, FIG. 6A-FIG. 6C. For example, the contour cap 20 may include one or more frangible zones 34 in the top 22 or in the one or more sidewalls 24 as shown in FIG. 6A. The one or more frangible zones 34 may comprise materials or a thickness that may be readily compromised, for example, with standard dental tools, yet remain sufficiently strong so as to not be compromised by the forces and pressures caused by biting, chewing, or brushing, or by tongue movement. Alternatively, the contour cap 20 may include a pull tab 36 connected to a frangible tear zone 34, FIG. 6C. The frangible tear zone 34 may comprise a thread 37, which may extend laterally across the top 22 of the contour cap 20, or may extend circumferentially around the one or more sidewalls 24 of the contour cap 20. The pull tab 36 may, for example, be connected to the thread 37 such that once pulled, the thread 37 compromises the frangible tear line 34. Alternatively, the contour cap 20 may include one or more ports 38 extending into and/or through the top 22 or the one or more sidewalls 24, that allow a wedge, such as a standard dental tool to be inserted into the contour cap 20 to disrupt or otherwise compromise the engagement of the one or more contour cap connectors 32 and the one or more healing cap connectors 50, as shown in FIG. 6B. The contour cap 20 may include one or more ports 38 on the top 22 or on the one or more sidewalls 24 that may be engaged and snared or hooked by a suitable tool such that the contour cap 20 may be pulled off of the healing cap 40 with sufficient force by a user (FIG. 6B).

In some aspects, the gingival tissue contour cap 20 may be expanded on one or more of its sides. Thus, for example, additional material such as a plastic, polymer, or composite thereof may be added to one or more sidewalls 24 to enlarge the dimension d, which may comprise the BL and/or MD dimensions. Expansion may be necessary, for example, in patients with a wider area where the implant is implanted, or to accommodate any irregularities in a given' patients gingival tissue.

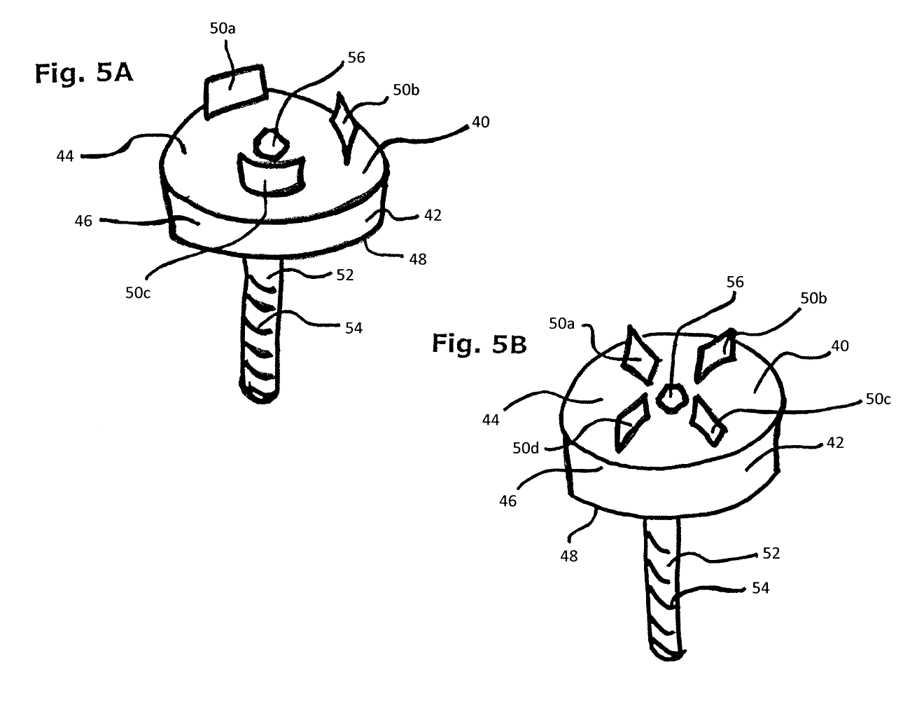

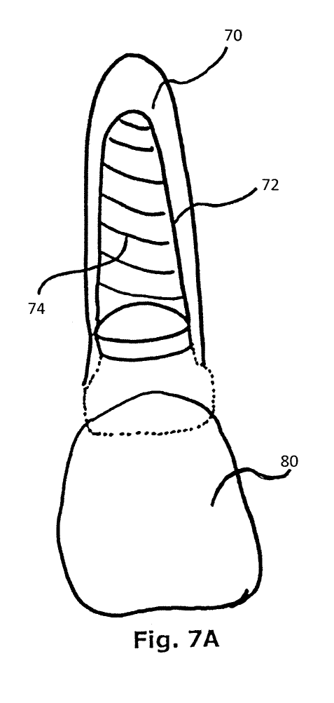

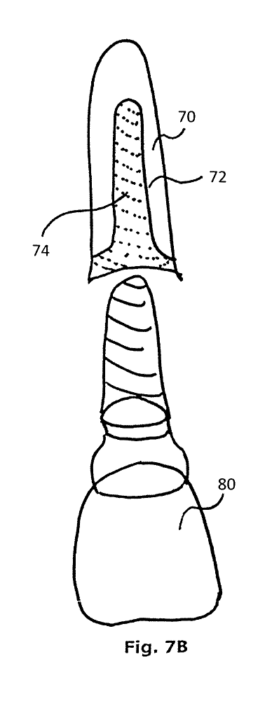

The gingival tissue contour system 10 may comprise a healing cap 40, such as, but not limited to, those shown in FIG. 1A-FIG. 1D, FIG. 3A-FIG. 3C, FIG. 5A and FIG. 5B. The healing cap 40 is preferably comprised entirely of a metal. The healing cap 40 comprises a head 42 having a top 44 and one or more sidewalls 46, as well as a bottom 48. The head 42 of the healing cap 40 preferably has a substantially cylindrical shape, and a substantially circular cross-shape, and preferably has no lip at or near the top. Integral with the head 42 of the healing cap 40 is a shaft 52 for insertion into the channel 72 of a dental implant 70, particularly when the dental implant 70 is implanted into the jaw of a patient. The shaft 52 extends in a downward, substantially vertical direction off of the bottom 48 of the healing cap 40, and the shaft 52 preferably is in a plane that is perpendicular to the plane of the top 44 and bottom 48 of the healing cap 40. The shaft 52 secures the healing cap 40 in place within the channel 72. To facilitate securing the healing cap 40 in place, the shaft 52 preferably comprises screw threads 54 that match with and engage complementary screw threads 74 on the channel 72 of the implant 70, as shown in FIG. 7A and FIG. 7B. Thus, in some aspects, the healing cap 40 preferably screws into and out of the implant 70. As the shaft 52 is integral with the head 42, it is preferred that the healing cap 40 does not include any central bore in which a separate screw may be inserted to secure the healing cap to the implant 70.

The healing cap 40 preferably also comprises a notch 56 in the top 44 of the head 42. The notch 56 functions, for example, to allow a user to use a tool such as a dental screw driver to rotate the healing cap 40 and screw the healing cap 40 in place within the implant 70, or to remove the healing cap 40 from the implant 70. The notch 56 may comprise any suitable shape, including a flat-head or slot shape, a hexagonal shape, a star shape, a cross/Phillips head shape, or any other shapes compatible with standard dentistry or surgical tools.

The healing cap 40 may be a standard healing cap 40 that includes modifications on the head 42 or the top 44 such as the inclusion of one or more healing cap connectors 50 that allow the healing cap 40 to match with and engage one or more gingival tissue contour cap connectors 32 present on the bottom 30 of the gingival tissue contour cap 20, FIG. 1A-1C, FIG. 3A-3C, FIG. 5A-FIG. 5B. Preferably, the one or more healing cap connectors 50 are integral with the head 42. The connectors 50 extends in an upward, substantially vertical direction off of the top 44 of the healing cap 40, and the one or more connectors 50 are preferably in a plane that is perpendicular to the plane of the top 44 and bottom 48 of the healing cap 40. The one or more healing cap connectors 50 serve to securely connect the healing cap 40 to the gingival tissue contour cap 20.

The size of the healing cap connector 50 may comprise, for example, about 30% to about 95% of the diameter/width of the head 42. The size of the healing cap connector 50 may comprise, for example, about 40% to about 70%, about 40% to about 80%, about 40% to about 90%, about 45% to about 80%, about 45% to about 75%, about 50% to about 90%, about 50% to about 85%, about 50% to about 80%, about 60% to about 90%, about 60% to about 80%, about 65% to about 75%, about 65% to about 85%, about 70% to about 90%, about 75% to about 85%, or about 80% to about 90% of the diameter/width of the head 42.

The one or more healing cap sidewalls 46 have a height h′. The height h′ may be about 0.5 mm to about 8 mm, and preferably about 1 mm to about 5 mm, about 1 mm to about 4 mm, about 1 mm to about 3 mm, about 1 mm to about 2 mm, about 2 mm to about 4 mm, about 2 mm to about 3 mm, about 2 mm to about 5 mm, about 3 mm to about 5 mm, about 3 mm to about 6 mm, or about 4 mm to about 6 mm. The height h′ is preferably less than the depth of a patient's gingival tissue, measured from the top of the gingival tissue to the top of the bone. In highly preferred aspects, the height h′ of the healing cap sidewalls 46 is about equal to the height h of the gingival tissue contour cap 20 sidewalls 24. Thus, the height h′ of the healing cap sidewalls 46, when combined with the height h of the contour cap sidewalls 24 equals about the depth of the patient's gingival tissue as measured from the top of the gingival tissue to the top of the bone. The user may combine a healing cap 40 having one or more sidewalls 46 with a suitable height h′ and a contour cap 20 having one or more sidewalls 24 with a suitable height h to accommodate a particular patient's gingival tissue depth. In some aspects, the combined healing cap sidewall 46 height h′ and contour cap sidewall 24 height h may equal the height of a standard healing cap used in present dental implant procedures, in which the standard healing cap is not used in combination with a contour cap and includes no connectors 50.

In some aspects, the healing cap 40 comprises one healing cap connector 50, which may, for example, be a raised flange 50, FIG. 1B and FIG. 1C, or a post 50, FIG. 1D. The raised flange 50 or post 50 may have any suitable shape, including a substantially circular, substantially elliptical, substantially triangular, substantially rectangular, substantially hexagonal, or substantially octagonal shape, though other shapes having any number of sides, including irregular shapes, can be used, including a star-shape. The flange 50 or post 50 may engage a complementary socket 32 on the bottom 30 of the tissue contour cap 20. The flange 50 or post 50 is preferably vertically-oriented, for example, perpendicular to a patient's jaw plane.

The flange 50 or post 50 may comprise a plurality of barbs or hooks 53 (FIG. 1C), may comprise a tongue 53, may comprise a lip, may comprise one or more grooves, and may comprise screw threads 51, FIG. 1B. In some aspects, the flange 50 may comprise structural features that do not impede the initial connection between the healing cap connector 50 and the contour cap connector 32 when the user is connecting the contour cap 20 and the healing cap 40 together, but are adapted to engage a complementary structural feature on the contour cap 20, including the contour cap connector 32, to further strengthen and secure the connection once made. The structural features may be spring-loaded, or may be sufficiently flexible so as not to impede the initial connection between the connectors, but to flex back and lock into place once the contour cap 20 and the healing cap 40 are in the proper orientation in the patient's mouth.

The one or more, or plurality of barbs or hooks 53, ridges 53, undercuts 53, or tongues 53, if present, may engage one or more, or a plurality of slots 31, notches 31, grooves 31, loops 31, or undercuts 31 on the contour cap connector 32, in order to help secure the connection between the contour cap 20 and the healing cap 40. A lip 53, tongue, 53, or ridge 53, if present, may engage a groove 31 along the perimeter on the contour cap 20. The one or more grooves 53, if present, may engage one or more tongues 31, lips 31 or ridges 31 on the contour cap 20. The screw threads 51, if present, may engage complementary screw threads 23 on the contour cap 20. Such additional structures may lock the contour cap 20 and healing cap 40 together apart from a tight friction fit between the base/main structures.

In some aspects, the healing cap 40 comprises more than one healing cap connector 50, which may, for example, comprise a plurality of fasteners 50. The healing cap 40 may comprise two, three, four, five, six, seven, eight, nine, ten, or more fasteners 50. FIG. 3A and FIG. 5A show a non-limiting embodiment with three fasteners 50a, 50b, and 50c. FIG. 5B shows a non-limiting embodiment with four fasteners 50a, 50b, 50c, and 50d. FIG. 5A and FIG. 5B shows that the fasteners may be oriented in different shapes and directions, including a substantially circular or elliptical orientation (FIG. 5A) and a substantially cross-like orientation, FIG. 5B. As with the flange 50, a fastener 50 may comprise structural features that do not impede the initial connection between the healing cap connector 50 and the contour cap connector 32 when the user is connecting the contour cap 20 and the healing cap 40 together, but are adapted to engage the a complementary structural feature on the contour cap 20, including the contour cap connectors 32, to further strengthen and secure the connection once made. The structural features may be spring-loaded, or may be sufficiently flexible so as not to impede the initial connection between the connectors, but to flex back and lock into place once the contour cap 20 and the healing cap 40 are in the proper orientation in the patient's mouth. Each fastener 50, or fewer than each fastener 50, may comprise one or a plurality of barbs or hooks 53, tongues 53, lips 53, or may comprise one or more grooves 53. The fastener 50 may comprise, for example, a post, flange, prong, rivet, snap button, clasp, or clip. The one or more fasteners 50 are preferably vertically-oriented, for example, perpendicular to a patient's jaw plane.

In some aspects, the healing cap 40 comprises one or more sockets 50, FIG. 3A-FIG. 3C. Thus, the healing cap connector 50 may engage a flange 32, a post 32, or a plurality of fasteners 32 on the gingival tissue contour cap 20. For example, such a configuration comprises the reciprocal of a socket 32 on the gingival tissue contour cap 32 and a raised flange 50, post, 50, or fastener 50 on the healing cap 40, such as those shown in FIG. 1A-FIG. 1D. FIG. 3A shows a non-limiting embodiment with three sockets 50a, 50b, and 50c. The one or more sockets 50 may comprise screw threads 51 (FIG. 3B), or may comprise one or more grooves 53, or may comprise one more slots or notches 53, for example, to accommodate barbs 31 or a tongue 31 on the contour cap connector 32.

When the contour cap 20 and the healing cap 40 are joined, it is preferable that aside from the healing cap connector 50 and its component structures (which may be inserted into a contour cap connector 32), no part of the healing cap head 42 passes into the contour cap 20. In other words, in highly preferred embodiments, the bottom 30 of the healing cap 20 effectively sits directly on top of the top 44 of the healing cap 40, but the top 44 of the healing cap 40 is not inserted into any portion of the contour cap 20.

The systems may comprise, for example, a gingival tissue contour cap 20, a healing cap 40, and a dental implant 70. The systems may comprise, for example, a gingival tissue contour device 10 and a dental implant 70. The gingival tissue contour cap 20 may be any of the gingival tissue contour caps 20 described or exemplified herein, and may comprise any of the features, including but not limited to the shapes, dimensions d, height h, and connectors 32 (+/−grooves 31, etc.), as well as frangible zones 34, described or exemplified herein. The dental implant 70 may be any suitable implant 70, including standard dental implants 70.

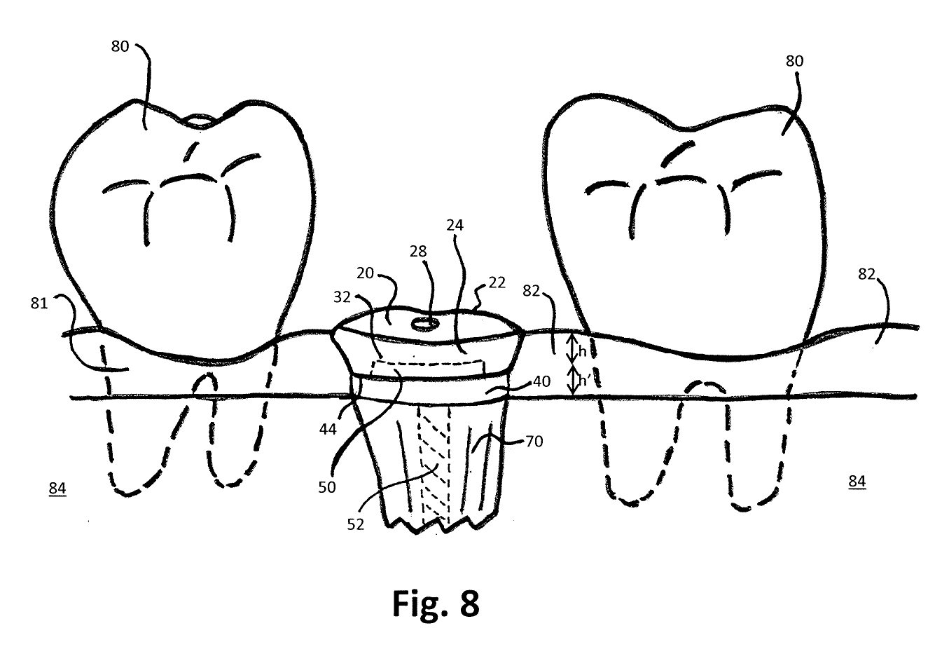

FIG. 8 shows a non-limiting example of a system used and installed in the jaw of a patient. For example, FIG. 8 shows two of the patient's natural teeth 80, with the roots 81 of each tooth 80 passing through the gingival tissue 82 and embedded in the jaw bone 84. Between each tooth 80, a dental implant 70 has been implanted into the jaw bone 84. A healing cap 40 has been secured to the dental implant 70, for example, by screwing the healing cap 40 into the implant 70. A gingival tissue contour cap 20 has been secured to the top 44 of the healing cap 40 by way of healing cap connectors 50a and 50b inserted into contour cap connectors 32a and 32b. The sidewalls 24 of the gingival tissue contour cap 20 comprise the cross-sectional shape and BL/MD dimensions of the neighboring teeth 80 so as to allow the gingival tissue 82 to assume that cross-sectional shape and BL/MD dimensions as the tissue 82 heals around the sidewalls 24 of the contour cap 20. The combined height h of the contour cap 20 and the height h′ of the healing cap 40 comprise substantially the depth of the gingival tissue 82.

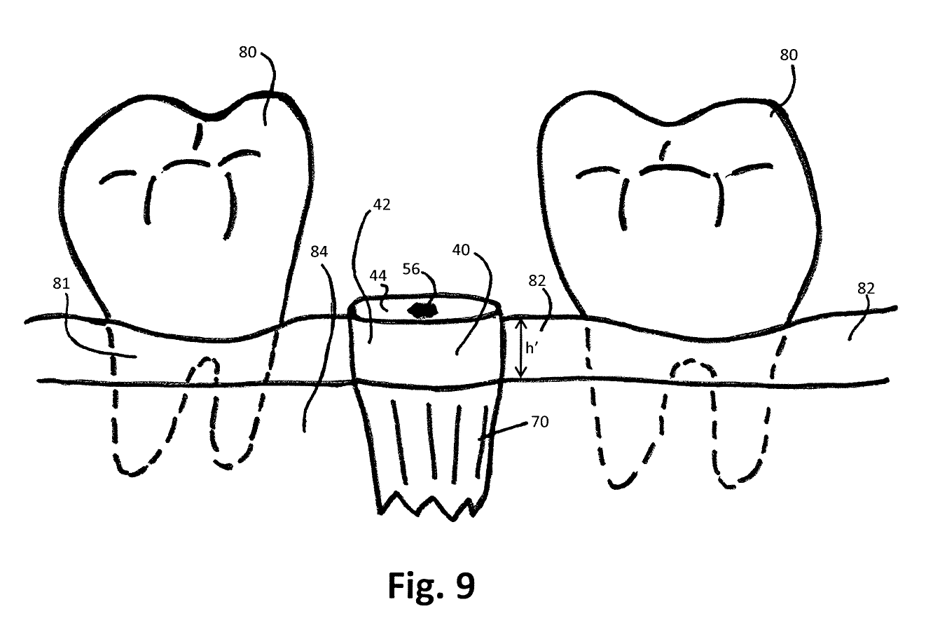

By way of comparison, FIG. 9 illustrates an example of a conventional healing cap 40 installed in the jaw of a patient along with a dental implant 70. FIG. 9 shows two of the patient's natural teeth 80, with the roots 81 of each tooth 80 passing through the gingival tissue 82 and embedded in the jaw bone 84. Between each tooth 80, a dental implant 70 has been implanted into the jaw bone 84. A healing cap 40 with a cylindrical-shaped head 42 and a substantially circular cross-sectional shape, and having a notch 56, has been secured to the dental implant 70, for example, by screwing the healing cap 40 into the implant 70. The height h′ of the healing cap 40 by itself spans the depth of the gingival tissue 82.

The invention also features kits for contouring gingival tissue. In some aspects, the kits comprise a gingival tissue contour cap 20, a healing cap 40, and instructions for using the kit in a method for contouring gingival tissue. The gingival tissue contour cap 20 of the kit may be any gingival tissue contour cap 20 described or exemplified herein, and may comprise any feature of a gingival tissue contour cap 20 described or exemplified herein, including one or more tissue contour cap connectors 32, and including one or more frangible zones 34. The healing cap 40 of the kit may be any healing cap 40 described or exemplified herein, and may comprise any feature of a healing cap 40 described or exemplified herein, including one or more healing cap connectors 50.

In some aspects, the kits further comprise materials that may be added to the one or more sidewalls 24 of the tissue contour cap 20. These materials may include, for example, additional plastic, polymer, or composite that may be placed over and/or adhered to the one or more sidewalls 24 in order to expand the BL and/or MD dimension d of the contour cap 20, for example, if needed to adjust the shape or size of the contour cap 20. Adjustments may be warranted by the shape of the patient's mouth, other teeth, gingival tissue, bones, or other aspects of the patient. The materials may for example, melt or soften upon heating so as to be malleable and/or tacky, and preferably securely fuse with the sidewalls 24 when applied to the surface of the sidewalls 24. The kits may further comprise instructions for adding materials to the sidewalls 24 of the tissue contour cap 20.

In some aspects, the kits further comprise a dental implant 70. The dental implant 70 is preferably compatible with the healing cap 40 such that the healing cap 40 may be installed into the implant 70 when the implant 70 is implanted in a patient's jaw. The kits may further comprise instructions for implanting the implant 70 and for using the kit, including the tissue contour cap and the healing cap in a method for contouring gingival tissue.

The invention also features methods for contouring gingival tissue in a patient in need thereof. Generally, the methods comprise connecting a gingival tissue contour cap 20 to a healing cap secured 40 to a dental implant 70 implanted in the jaw of the patient for a period of time sufficient to allow the gingival tissue of the patient to grow and heal around one or more sidewalls 24 of the gingival tissue contour cap 20, thereby assuming the shape of the one or more sidewalls 24. The period of time may be measured in days, weeks, or months, and may vary, for example, based on the particular condition or needs of the patient.

The methods may further comprise removing the gingival tissue contour cap 20 from the healing cap 40. The methods may further comprise removing the healing cap 40 from the dental implant 70. Removal may take place, for example, after the gingival tissue has sufficiently grown and healed around the sidewalls 24 of the gingival tissue contour cap 20, and the gingival tissue is ready to accommodate the installation of a prosthetic tooth 80.

The methods may further comprise implanting the dental implant 70 into the jaw bone of the patient. The methods may further comprise implanting a prosthetic tooth 80 into the implant 70 after removing the healing cap 40 from the implant 70.

In any of the methods, the gingival tissue contour cap 20 may comprise any gingival tissue contour cap 20 described or exemplified herein, and may comprise any feature of a gingival tissue contour cap 20 described or exemplified herein, including one or more tissue contour cap connectors 32, and including one or more frangible zones 34. The healing cap 40 may also be any of those described or exemplified herein, and may comprise any feature of a healing cap 40 described or exemplified herein, including one or more healing cap connectors 50.

The invention is not limited to the embodiments described and exemplified above, but is capable of variation and modification within the scope of the appended claims.

What is claimed:

1. A gingival tissue contour system, comprising:
a gingival tissue contour cap comprising a top, one or more sidewalls comprising substantially the buccolingual dimension, the mesiodistal dimension, and the shape of the neck of a tooth, and a bottom having one or more connectors complementary to one or more connectors on a healing cap head; and,
a healing cap comprising a cylindrical and substantially round head having one or more connectors extending in an upward direction from the top of the head for engaging the one or more connectors on the gingival tissue contour cap and securing the gingival tissue contour cap to the top of the head, and a shaft extending in a downward direction from the bottom of the head and having screw threads compatible with the screw threads of a dental implant fixture.

2. The gingival tissue contour system of claim 1, wherein the one or more connectors on the head of the healing cap comprises a flange and the one or more connectors on the bottom of the gingival tissue contour cap comprises a socket.

3. The gingival tissue contour system of claim 1, wherein the one or more connectors on the head of the healing cap comprises a post and the one or more connectors on the bottom of the gingival tissue contour cap comprises a socket.

4. The gingival tissue contour system of claim 3, wherein the post comprises a tongue around the perimeter of the post, and the socket comprises a groove inside and around the perimeter of the socket for engaging the tongue.

5. The gingival tissue contour system of claim 1, wherein the gingival tissue contour cap sidewalls comprise substantially the maxillary buccolingual dimension and the maxillary mesiodistal dimension of a tooth type in Table 1.

6. The gingival tissue contour system of claim 1, wherein the gingival tissue contour cap sidewalls comprise substantially the mandibular buccolingual dimension and the mandibular mesiodistal dimension of a tooth type in Table 1.

7. The gingival tissue contour system of claim 1, wherein the gingival tissue contour cap sidewalls comprise substantially the buccolingual dimension, the mesiodistal dimension, and the shape of the neck of a maxillary central incisor tooth or a mandibular central incisor tooth.

8. The gingival tissue contour system of claim 1, wherein the gingival tissue contour cap sidewalls comprise substantially the buccolingual dimension, the mesiodistal dimension, and the shape of the neck of a maxillary lateral incisor tooth or a mandibular lateral incisor tooth.

9. The gingival tissue contour system of claim 1, wherein the gingival tissue contour cap sidewalls comprise substantially the buccolingual dimension, the mesiodistal dimension, and the shape of the neck of a maxillary cuspid tooth or a mandibular cuspid tooth.

10. The gingival tissue contour system of claim 1, wherein the gingival tissue contour cap sidewalls comprise substantially the buccolingual dimension, the mesiodistal dimension, and the shape of the neck of a maxillary first bicuspid tooth or a mandibular first bicuspid tooth.

11. The gingival tissue contour system of claim 1, wherein the gingival tissue contour cap sidewalls comprise substantially the buccolingual dimension, the mesiodistal dimension, and the shape of the neck of a maxillary second bicuspid tooth or a mandibular second bicuspid tooth.

12. The gingival tissue contour system of claim 1, wherein the gingival tissue contour cap sidewalls comprise substantially the buccolingual dimension, the mesiodistal dimension, and the shape of the neck of a maxillary first molar tooth or a mandibular first molar tooth.

13. The gingival tissue contour system of claim 1, wherein the gingival tissue contour cap sidewalls comprise substantially the buccolingual dimension, the mesiodistal dimension, and the shape of the neck of a maxillary second molar tooth or a mandibular second molar tooth.

14. The gingival tissue contour system of claim 1, wherein the healing cap comprises a notch substantially in the center of the top of the head for engaging a tool for turning the healing cap when the healing cap is placed in a dental implant fixture, and the gingival tissue contour cap comprises a bore extending from the top to the bottom and the bore aligns with the notch.

15. The gingival tissue contour system of claim 1, wherein the gingival tissue contour cap further comprises one or more frangible zones.

16. The gingival tissue contour system of claim 1, wherein the gingival tissue contour cap comprises one or more ports on the top or on one or more sidewalls, for removing the contour cap from the healing cap with a tool.

17. The gingival tissue contour system of claim 1, further comprising a dental implant.

18. A kit for contouring gingival tissue, comprising the gingival tissue contour system of claim 1, and instructions for using the system in a method for contouring gingival tissue.

19. The kit of claim 18, further comprising a plastic material, a polymeric material, or a composite material thereof for adhering to and enlarging the buccolingual dimension and/or the mesiodistal dimension of the gingival tissue contour cap, and instructions for using the plastic material, a polymeric material, or a composite material thereof to enlarge the buccolingual dimension and/or the mesiodistal dimension of the gingival tissue contour cap.

20. The kit of claim 18, further comprising a dental implant compatible with the healing cap, and optionally further comprising a prosthetic tooth.

21. A method for contouring gingival tissue in a patient in need thereof, comprising connecting the gingival tissue contour cap of claim 1 to the healing cap of claim 1 that has been inserted into a dental implant in the jaw of a patient for a period of time sufficient to allow the gingival tissue of the patient to grow and heal around the sidewalls of the gingival tissue contour cap, thereby assuming the shape of the sidewalls.
